(19) United States
(12) Patent Application Publication
(10) Pub. No.: US 2021/0240524 A1
(43) Pub. Date: Aug. 5, 2021

(54) METHODS AND APPARATUS TO FACILITATE TILE-BASED GPU MACHINE LEARNING ACCELERATION

(71) Applicant: QUALCOMM Incorporated, San Diego, CA (US)

(72) Inventors: Hitendra Mohan GANGANI, San Diego, CA (US); Balaji CALIDAS, San Diego, CA (US); Murat BALCI, San Diego, CA (US)

(21) Appl. No.: 16/779,275

(22) Filed: Jan. 31, 2020

(51) Int. Cl. G06F 9/48; G06N 20/00

(52) U.S. Cl. CPC G06F 9/4881; G06N 20/00

(57) ABSTRACT

The present disclosure relates to methods and apparatus for machine learning processing. For example, disclosed techniques facilitate tile-based GPU machine learning acceleration. Aspects of the present disclosure can determine a tile size based on a memory size of a first memory and a job input size associated with executing a computational job. In some examples, the computational job may be one of a quantity of computational jobs configured to execute a machine learning primitive. Aspects of the present disclosure can also load, based on the tile size, input data associated with a batch of computational jobs from a second memory to the first memory. Further, aspects of the present disclosure can generate batch output data by executing the batch of computational jobs using the input data loaded to the first memory. Additionally, aspects of the present disclosure can store the generated batch output data to the second memory.

### TECHNICAL FIELD

The present disclosure relates generally to processing systems and, more particularly, to one or more techniques for machine learning processing.

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a display processor, a display processing unit (DPU), or a video processor. The apparatus can determine a tile size based on a memory size of a first memory and a job input size associated with executing a computational job. In some examples, the computational job may be one of a quantity of computational jobs configured to execute a machine learning primitive. The apparatus can also load, based on the tile size, input data associated with a batch of computational jobs from a second memory to the first memory. Additionally, the apparatus can generate batch output data by executing the batch of computational jobs using the input data loaded to the first memory. Further, the apparatus can store the generated batch output data to the second memory.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system, in accordance with one or more techniques of this disclosure.

FIG. 2 is a block diagram illustrating components of the device of FIG. 1, in accordance with one or more techniques of this disclosure.

FIGS. 3 and 4 illustrate example flowcharts of example methods, in accordance with one or more techniques of this disclosure.

### DETAILED DESCRIPTION

In general, examples disclosed herein provide techniques for facilitating improving GPU machine learning acceleration via tile-based processing. In some examples, a GPU may be configured to perform graphics operations to render one or more graphics primitives, for example, to a display. In some examples, the GPU may additionally or alternatively be configured to execute machine learning (ML) operations to render one or more ML primitives. For example, the GPU may be configured to execute general-purpose “shader programs” in order to perform computations other than graphics operations. Due to the relative highly parallel nature of GPU processing elements, some types of calculations may be more efficiently performed by a GPU than, for example, by a CPU.

For example, processing elements of the GPU may be configured to operate as a single instruction, multiple data (SIMD) system. In a SIMD system, a plurality of processing elements of the GPU each execute instructions of a same shader program, but on different data. A particular instruction executing on a particular processing element may be referred to as a “computational job,” a “thread,” or a “fiber.” Each processing element of the GPU may be considered as executing a different computational job because the data for a given computational job may be different. However, the instruction executing on a processing element is the same instruction of the same shader program as the instruction executing on the other processing elements. In this manner, the SIMD structure of the processing elements of the GPU allows the GPU to perform many tasks in parallel (e.g., at the same time) and, thus, facilitates GPU-based acceleration of some calculations.

As an illustrative example, an application being executed via a CPU, such as a video game, may include a graphics engine to facilitate the rendering of graphics (e.g., by providing graphics operations to a GPU) and a game difficulty engine to determine a level of difficulty of gameplay to provide a user. In some examples, the game difficulty engine may update (e.g., periodically, aperiodically, event-based, and/or as a one-time event) the level of difficulty of gameplay based on player actions and/or events. For example, if the player is having difficulty advancing beyond an obstacle, the game difficulty engine may determine to lower the level of difficulty of gameplay.

In some examples, the game difficulty engine may use machine learning techniques to determine the appropriate level of gameplay difficulty to provide the player. In some examples, the CPU may offload some functionality of the game difficulty engine to the GPU. For example, the CPU may provide ML commands and ML data to the GPU for processing. Examples of ML commands include ML primitives, such as convolution operations, general matrix multiply (GEMM) operations, pooling operations, batch normalization operations, image processing operations, etc. Examples of ML data may include primitive information, state information, constants data, etc. that may be used by the GPU when executing the ML primitives.

In some examples, the CPU may provide the ML commands and the ML data to the GPU by storing the ML commands and the ML data in a memory that is accessible to the CPU and the GPU. The CPU may then instruct the GPU to access the ML commands and the ML data from the memory. However, it should be appreciated that memory latency may be associated with accessing (e.g., reading and/or writing) data at the memory, due to, for example, a memory bus that may be shared by other components of the device.

Example techniques disclosed herein use a GPU memory (GMEM) that is directly coupled to the GPU. For example, the GPU may receive ML commands associated with an ML primitive, may load the ML data corresponding to the ML primitive from the memory to the GMEM, execute the ML commands using the ML data at the GMEM, and then write the outputs of the ML commands to the memory. In some examples, the GMEM may be an on-chip memory that is on-chip with the GPU, is in relatively close proximity with components of the GPU, and may be associated with a dedicated memory bus within the GPU that provides a relatively high memory bandwidth to the GPU so that processing elements of the GPU can efficiently access the data at the GMEM. In contrast, to access data stored at the memory accessible to the CPU and the GPU (sometimes referred to as a “system memory,” a “global memory,” or a “shared memory”), the GPU may have to share a memory bus with other components of the device, such as the CPU, which may result in a more limited available bandwidth.

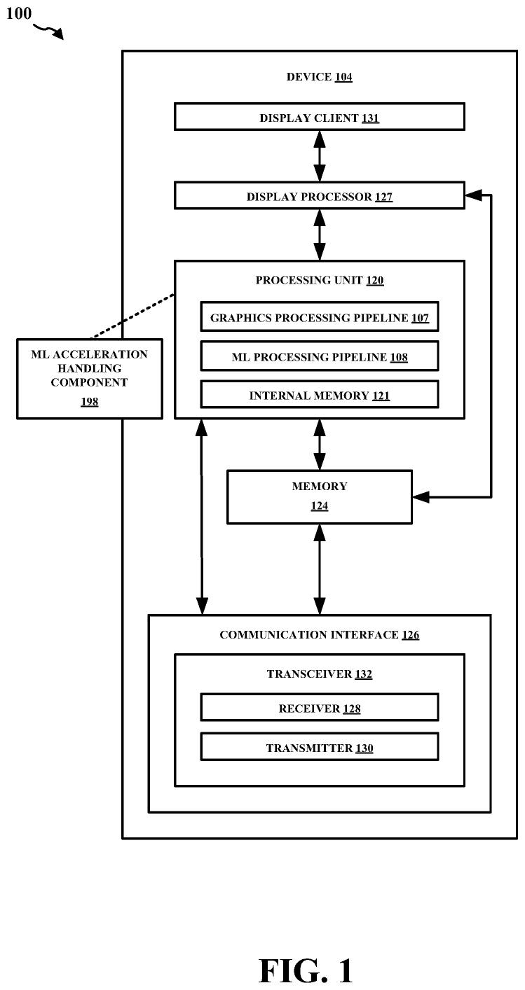

In some examples, executing an ML primitive may correspond to generating a quantity of outputs. In some such examples, the quantity of computational jobs (sometimes referred to as “threads” or “fibers”) launched to execute the ML primitive may depend on the quantity of outputs generated by the executing of each computational job. For example, executing an ML primitive may result in 1000 outputs being generated. However, to generate the 1000 outputs, the GPU may launch 100 computational jobs that each generate 10 job outputs. In some examples, executing the ML primitive may include mapping the ML primitive to a shader program and executing the shader program at the GPU. A shader program may represent the software and/or firmware executed by the GPU for implementing a pipeline, such as the graphics processing pipeline 107 of FIG. 1 and/or the ML processing pipeline 108 of FIG. 1. In some such examples, the quantity of job outputs generated by the execution of each computational job may depend on the structure of the shader program. For example, a developer of the shader program may determine the quantity of job outputs that are generated by the execution of each computational job. Thus, it should be appreciated that in some examples, the quantity of job output(s) that may be generated by the execution of a computational job associated with an ML primitive may be determined based on the shader program that maps to the ML primitive.

However, because the size of the GMEM may be limited due to physical area constraints, it should be appreciated that the GMEM may not have sufficient memory to store the ML data from the memory for executing the ML commands associated with the ML primitive. For example, a system memory may store gigabytes (GBs) of data, the system memory may store megabytes (MBs) of ML data, and the GMEM may be able to store kilobytes (KBs) of data.

Accordingly, example techniques disclosed herein facilitate dividing the computational jobs and corresponding ML data into tiles based on, for example, the memory size of the GMEM and the memory size associated with executing each computational job. In some examples, the memory size associated with executing each computational job may depend on the quantity of inputs (and their respective size) used to execute the computational job. For example, executing one computational job may include loading ML data into one memory unit of the GMEM, while the memory size of the GMEM may be ten memory units. In some such examples, a tile may correspond to ten computational jobs (sometimes referred to as a “batch of computational jobs”). Furthermore, the size of the tile may correspond to the quantity of computational jobs of the batch of computational jobs (e.g., the tile size is ten computational jobs in the above example).

Example techniques disclosed herein determine a tile size and then load input data associated with a batch of computational jobs to the GMEM. For example, disclosed techniques may load input data for executing ten computational jobs from the system memory to the GMEM. Example techniques may then execute the ten computational jobs using the input data loaded on the GMEM. Accordingly, example techniques disclosed herein facilitate reducing memory read latency by reducing the need for the GPU to access the input data at the time of execution of each computational job. That is, rather than determining to execute a computational job, accessing the system memory for input data associated with the executing of the computational job, and then executing the computational job, disclosed techniques determine a quantity of computational jobs to execute (e.g., a first batch of computational jobs), load the respective input data from the system memory to the GMEM, and then execute the first batch of computational jobs using the input data loaded to the GMEM. Example techniques may then dispatch the first batch of computational jobs by writing the output data generated by the executing of the first batch of computational jobs (sometimes referred to as “batch output data”) to the system memory while loading input data (e.g., from the system memory to the GMEM) associated with a second batch of computational jobs. In this manner, example techniques facilitate interleaving the loading of input data (e.g., from the system memory to the GMEM) and the storing of output data (e.g., from the GMEM to the system memory) between each dispatch of computational jobs.

In some examples, the processing elements of the GPU may be able to write to the GMEM. For example, one or more processing elements of the GPU may execute a computational job and write the output of the computational job (sometimes referred to as “job output data”) to the GMEM. In some such examples, the GPU may facilitate the writing of the job output data generated by the executing of each computational job of the first batch of computational jobs to the GMEM. As described above, the GMEM may provide relatively high memory bandwidth to the GPU compared to a memory bus shared by other components of the device. Accordingly, in some such examples, example techniques disclosed herein may facilitate reducing memory write latency by reducing the need for the GPU to write the job output data to the system memory at the time of execution of each computational job. Instead, by enabling the GPU to write the respective job output data to the GMEM, disclosed techniques facilitate writing the batch output data to the system memory at one time, for example, after the executing of the first batch of computational jobs is complete and during the dispatching of the first batch of computational jobs.

In some such examples in which the processing elements may write to the GMEM, disclosed techniques may facilitate dividing the computational jobs and corresponding ML data into tiles based on, for example, the memory size of the GMEM, the memory size of job input data (e.g., the input data used to execute one computational job), and the memory size of job output data (e.g., the output data generated by the executing of one computational job). For example, executing one computational job may be associated with job input data using one memory unit of the GMEM and job output data using one memory unit of the GMEM. In some such examples (and referring to the above example in which the memory size of the GMEM may be ten memory units), a size of a tile may correspond to five computational jobs (e.g., a batch of computational jobs includes five computational jobs).

As used herein, a tile may refer to a logical block of memory associated with a respective batch of computational jobs. A size of a tile (or “tile size”) may indicate the quantity of computational jobs that may be associated with a tile. For example, in the above example in which the memory size of the GMEM is ten memory units and the memory resources associated with a computational job is two memory units (e.g., one memory unit associated with the job input data and one memory unit associated with the job output data), the size of the tile may be determined to be five computational jobs. Furthermore, if executing an ML primitive includes executing ten computational jobs, then five computational jobs may be assigned to a first tile and the remaining five computational jobs may be assigned to a second tile. In some examples, computational jobs may be assigned to a respective tile based on a formula. For example, each computational job may be associated with a respective identifier and, thus, the computational job identifier may be used to map the computational job to its respective tile. However, it should be appreciated that other examples may employ additional or alternative techniques for assigning computational jobs to respective tiles.

It should be appreciated that regardless of whether the processing elements of the GPU are capable of writing to the GMEM, after a batch of computational jobs is complete, disclosed techniques may load job input data for a second batch of computational jobs from the system memory to the GMEM, execute the second batch of computational jobs using the job input data stored at the GMEM, and then write the job output data to the system memory. Furthermore, it should be appreciated that disclosed techniques enable the repeating of the loading of job input data from the memory to the GMEM, the executing of computational jobs using the job input data loaded at the GMEM, and the writing of the job output data to the system memory for each subsequent batch of computational jobs. For example, referring to the above example in which the GPU may launch 100 computational jobs that each generate 10 job outputs to generate the 1000 ML primitive outputs, disclosed techniques may determine the quantity of batches of computational jobs to launch (or the number of tiles) based on the tile size and the total number of computational jobs (e.g., 100 computational jobs in the above example). For example, in the above example in which the processing elements do not write to the GMEM and a tile size of ten computational jobs, disclosed techniques may employ ten batches of ten computational jobs each to generate the 1000 ML primitive outputs. Accordingly, it should be appreciated that the quantity of batches needed for executing the ML primitive may depend on the memory resources associated with executing each computational job associated with the ML primitive (e.g., the memory size of the job input data and the memory size of the job output data when the processing elements are capable of writing to the GMEM).

Thus, it should be appreciated that example techniques disclosed herein facilitate tile-based GPU machine learning acceleration. Furthermore, disclosed techniques facilitate improving performance of executing ML primitives by reducing memory read latency. In some examples, disclosed techniques may also facilitate improving performance of executing ML primitives by reducing memory write latency.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application (e.g., software) being configured to perform one or more functions. In such examples, the application may be stored on a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, examples disclosed herein provide techniques for tile-based GPU machine learning acceleration. Example techniques may improve performance and reduce power consumption associated with executing ML primitives by determining a size of a tile (e.g. a tile size) based on a size of a memory (e.g., a memory size of a GMEM and a memory size associated with executing a computational job associated with an ML primitive), determining a quantity of tiles to execute based on the ML primitive and outputs of each of the computational jobs, and interleaving memory load and memory write operations between the system memory, the GPU, and the GMEM between execution of each batch. For example, disclosed techniques enable interleaving memory access by writing batch output data generated by the execution of a first batch of computational jobs from the GMEM to the system memory while loading input data associated with a second batch of computational jobs from the system memory to the GMEM. Thus, it should be appreciated that examples disclosed herein provide techniques for reducing the load on a communication interface (e.g., a bus), and/or reducing the load of a processing unit (e.g., any processing unit configured to perform one or more techniques disclosed herein, such as a GPU, a DPU, and the like). For example, this disclosure describes techniques for system processing in any device that utilizes machine learning techniques. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to content produced by one or more processes of a graphics processing pipeline. In some examples, as used herein, the term “graphical content” may refer to content produced by a processing unit configured to perform graphics processing. In some examples, as used herein, the term “graphical content” may refer to content produced by a graphics processing unit.

In some examples, as used herein, the term “display content” may refer to content generated by a processing unit configured to perform display processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling (e.g., upscaling or downscaling) on a frame. In some examples, a frame may refer to a layer. In other examples, a frame may refer to two or more layers that have already been blended together to form the frame (e.g., the frame includes two or more layers and the frame that includes two or more layers may subsequently be blended).

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 includes a processing unit 120 and a system memory 124. In some examples, the device 104 can include a number of additional or alternative components, such as a communication interface 126, a transceiver 132, a receiver 128, a transmitter 130, a display processor 127, and a display client 131.

In the illustrated example of FIG. 1, the processing unit 120 includes an internal memory 121. The processing unit 120 may be configured to perform graphics processing, such as in a graphics processing pipeline 107. The processing unit 120 may also be configured to perform ML processing, such as in an ML processing pipeline 108. In some examples, the device 104 may include a display processor, such as the display processor 127, to perform one or more display processing techniques on one or more frames generated by the processing unit 120 before presentment by the display client 131. The display processor 127 may be configured to perform display processing. For example, the display processor 127 may be configured to perform one or more display processing techniques on one or more frames generated by the processing unit 120.

Reference to the display client 131 may refer to one or more displays. For example, the display client 131 may include a single display or multiple displays. The display client 131 may include a first display and a second display. In further examples, the results of the graphics processing may not be displayed on the device (e.g., the first and second displays may not receive any frames for presentment thereon). Instead, the frames or graphics processing results may be transferred to another device. The display client 131 may be configured to display or otherwise present frames processed by the display processor 127. In some examples, the display client 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120, such as the memory 124, may be accessible to the processing unit 120. For example, the processing unit 120 may be configured to read from and/or write to external memory, such as the memory 124. The processing unit 120 may be communicatively coupled to the memory 124 over a bus. In some examples, the processing unit 120 and the memory 124 may be communicatively coupled to each other over the bus or a different connection.

It should be appreciated that in some examples, the device 104 may include a content encoder/decoder configured to receive graphical and/or display content from any source, such as the memory 124 and/or the communication interface 126. The memory 124 may be configured to store received encoded or decoded content. In some examples, the content encoder/decoder may be configured to receive encoded or decoded content (e.g., from the memory 124 and/or the communication interface 126) in the form of encoded pixel data. In some examples, the content encoder/decoder may be configured to encode or decode any content.

The internal memory 121 or the memory 124 may include one or more volatile or non-volatile memories or storage devices. In some examples, the internal memory 121 or the memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the memory 124 may be a non-transitory storage medium according to some examples. The term “non-transitory” may indicate that the storage medium is not embodied in a carrier wave or a propagated signal. However, the term “non-transitory” should not be interpreted to mean that the internal memory 121 or the memory 124 is non-movable or that its contents are static. As one example, the memory 124 may be removed from the device 104 and moved to another device. As another example, the memory 124 may not be removable from the device 104.

The processing unit 120 may be a central processing unit (CPU), a graphics processing unit (GPU), a general purpose GPU (GPGPU), or any other processing unit that may be configured to perform system processing, such as graphics processing, compute processing, ML processing, etc. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium (e.g., the internal memory 121) and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include a communication interface 126. The communication interface 126 may include a receiver 128 and a transmitter 130. The receiver 128 may be configured to perform any receiving function described herein with respect to the device 104. Additionally, the receiver 128 may be configured to receive information (e.g., eye or head position information, rendering commands, and/or location information) from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

In some examples, the graphical content from the processing unit 120 for display via the display client 131 is not static and may be changing. Accordingly, the display processor 127 may periodically refresh the graphical content displayed via the display client 131. For example, the display processor 127 may periodically retrieve graphical content from the system memory 124, where the graphical content may have been updated by the execution of an application (and/or the processing unit 120) that outputs the graphical content to the system memory 124.

It should be appreciated that while shown as separate components in FIG. 1, in some examples, the display client 131 (sometimes referred to as a “display panel”) may include the display processor 127. Furthermore, in some examples, the processing unit 120 may include the display processor 127.

Referring again to FIG. 1, in certain aspects, the processing unit 120 may be configured to perform graphics operations to render one or more graphics primitives to display, for example, via the display client 131. In some examples, the processing unit 120 may be configured to execute general-purpose “shader programs” in order to perform computations for applications other than graphics (e.g., for executing machine learning techniques). In the illustrated example of FIG. 1, the processing unit 120 may include an ML acceleration handling component 198 configured to facilitate GPU machine learning acceleration via tile-based processing. For example, the ML acceleration handling component 198 may be configured to determine a tile size based on a memory size of a first memory and a job input size associated with executing a computational job, and where the computational job is one of a quantity of computational jobs configured to execute an ML primitive. The example ML acceleration handling component 198 may also be configured to load, based on the tile size, input data associated with a batch of computational jobs from a second memory to the first memory. The example ML acceleration handling component 198 may also be configured to generate batch output data by executing the batch of computational jobs using the input data loaded to the first memory. Additionally, the example ML acceleration handling component 198 may be configured to store the generated batch output data to the second memory.

In some examples, the example ML acceleration handling component 198 may be configured to determine the job input size associated with executing the computational job based on a memory size of input data used to execute the computational job. In some examples, the example ML acceleration handling component 198 may be configured to determine the tile size further based on a job output size associated with executing the computational job. In some such examples, the job output size may be based on a memory size of output data generated by the execution of the computational job. In some examples, the example ML acceleration handling component 198 may be configured to store the generated batch output data to the second memory by writing the output data generated by the execution of each computational job of the batch of computational jobs to the first memory, and storing the generated output data from the first memory to the second memory after execution of the batch of computational jobs is complete. In some examples, the batch of computational jobs may be a first batch of computational jobs and the example ML acceleration handling component 198 may be configured to load input data associated with a second batch of computational jobs from the second memory to the first memory, the loading of the input data associated with the second batch of computational jobs being performed in parallel with the storing of the generated output data to the second memory after execution of the first batch of computational jobs is complete.

In some examples, the example ML acceleration handling component 198 may be further configured to load second input data associated with a second batch of computational jobs from the second memory to the first memory, to generate second batch output data by executing the second batch of computational jobs using the second input data loaded to the first memory, and to store the generated second batch output data to the second memory.

In some examples, the first memory may be associated with a first latency and the second memory may be associated with a second latency that is greater than the first latency. In some examples, the first memory may be an on-chip memory of a graphics processor. In some examples, the graphics processor may include a plurality of processing elements configured to execute the batch of computational jobs. In some examples, the tile size may correspond to a quantity of computational jobs of the batch of computational jobs.

As described herein, a device, such as the device 104, may refer to any device, apparatus, or system configured to perform one or more techniques described herein. For example, a device may be a server, a base station, user equipment, a client device, a station, an access point, a computer (e.g., a personal computer, a desktop computer, a laptop computer, a tablet computer, a computer workstation, or a mainframe computer), an end product, an apparatus, a phone, a smart phone, a server, a video game platform or console, a handheld device (e.g., a portable video game device or a personal digital assistant (PDA)), a wearable computing device (e.g., a smart watch, an augmented reality device, or a virtual reality device), a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, can be performed using other components (e.g., a CPU), consistent with disclosed embodiments.

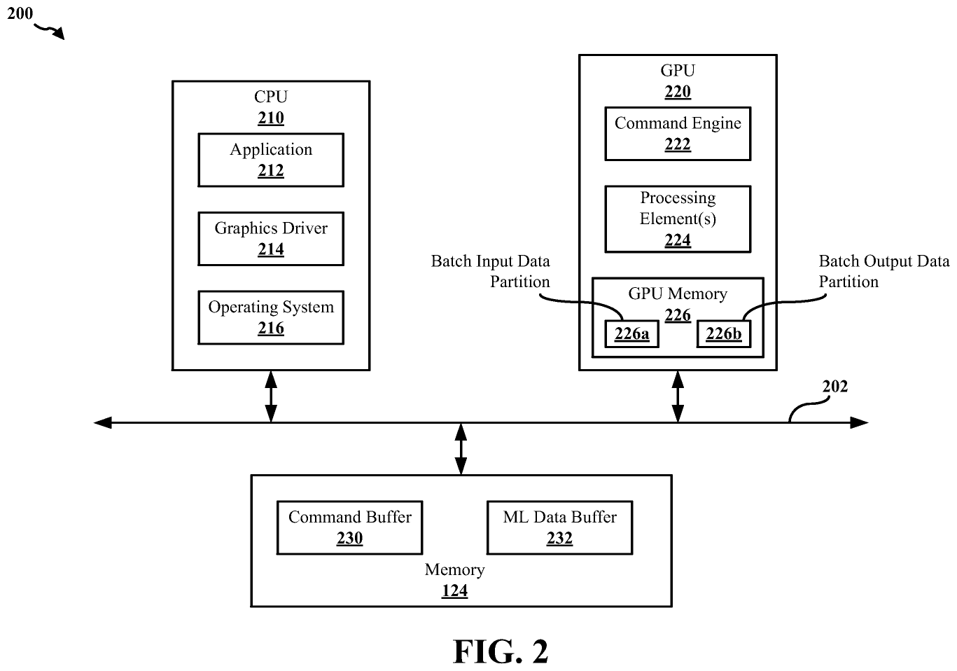

FIG. 2 is a block diagram 200 illustrating components of a device, such as the example device 104 of FIG. 1, in accordance with aspects of this disclosure. In the illustrated example of FIG. 2, the block diagram 200 includes a CPU 210, a GPU 220, and the memory 124. In some examples, the CPU 210 and the GPU 220 may implement one or more aspects of the processing unit 120 of FIG. 1. For example, the CPU 210 and/or the GPU 220 may facilitate implementing one or more aspects of the ML acceleration handling component 198 of FIG. 1. As shown in FIG. 2, the example CPU 210, the example GPU 220, and the example memory 124 are in communication via an example bus 202. The example bus 202 may be implemented using any combination of bus structures and/or bus protocols.

In the illustrated example of FIG. 2, the CPU 210 may include one or more processors that are configured to execute an application 212, a graphics driver 214, and/or an operating system 216. The example GPU 220 of FIG. 2 may include one or more processors that are configured to execute a command engine 222, one or more processing element(s) 224, and a GPU memory 226. The example memory 124 of FIG. 2 may be configured to store a command buffer 230 and an ML data buffer 232.

In some examples, the CPU 210 may be configured to execute instructions that cause the CPU 210 to perform one or more of the example techniques disclosed herein. In some examples, the GPU 220 may be configured to execute instructions that cause the GPU 220 to perform one or more of the example techniques disclosed herein. In some examples, the memory 124 may store instructions that, when executed, cause the CPU 210 and/or the GPU 220 to perform one or more of the example techniques disclosed herein.

In the illustrated example, the CPU 210 may be configured to execute the application 212. The application 212 may be an application that offloads the performing of ML tasks to the GPU 220. For example, the CPU 210 may use the GPU 220 to execute one or more ML primitives. For example, the application 212 may include operations that cause the GPU 220 to execute one or more computational jobs associated with an ML primitive. In some examples, the application 212 may issue the operations to the graphics driver 214. In some examples, the graphics driver 214 may include a runtime service (e.g., an application programming interface (API)) configured to translate the operations received from the application 212 into a format that is consumable by the graphics driver 214 for providing to the GPU 220.

The example graphics driver 214 may receive the operations from the application 212 and may control operation of the GPU 220 to facilitate executing the operations. For example, the graphics driver 214 may generate one or more command streams, store the generated command streams in the command buffer 230 of the memory 124, and instruct the GPU 220 to execute the command streams. In some examples, the graphics driver 214 may store the command streams into the command buffer 230 and communicate with the GPU 220 via the operating system 216 (e.g., via one or more system calls).

The example operating system 216 may provide a software platform upon which the application 212 and the graphics driver 214 may operate. In some examples, the operating system 216 may manage hardware details related to communicating and/or transferring of data between the CPU 210, the GPU 220, and/or the memory 124.

In the illustrated example of FIG. 2, the GPU 220 may be configured to execute commands that are issued to the GPU 220 by the CPU 210. The commands executed by the GPU 220 may include general-purpose computing commands, graphics commands, state programming commands, memory transfer commands, etc. In some examples, the GPU 220 may be configured to perform graphics operations to render one or more graphics primitives for presentment (e.g., via the display client 131 of FIG. 1). In some such examples, when the application 212 executing on the CPU 210 requires graphics processing, the CPU 210 may provide graphics data to the GPU 220 for rendering and issue one or more graphics commands to the GPU 220. The graphics data may include vertex buffers, texture data, surface data, etc. In some examples, the CPU 210 may provide the graphics commands and the graphics data to the memory 124, which may be accessed by the GPU 220.

In some examples, the GPU 220 may be configured to execute general-purpose “shader programs” to facilitate executing computations for applications other than graphics. For example, the GPU 220 may be configured to execute ML primitives, such as convolution operations, GEMM operations, pooling operations, batch normalization operations, image processing operations, etc. In some such examples, when the application 212 executing on the CPU 210 requires ML processing, the CPU 210 may provide ML data to the GPU 220 for processing and issue one or more ML commands to the GPU 220. The ML data may include primitive data used for executing the ML commands. In some examples, the CPU 210 may store the ML commands in the command buffer 230 and may store the ML data in the ML data buffer 232 of the memory 124, which may be accessed by the GPU 220.

In some examples, the command engine 222 and the one or more processing elements 224 of the GPU 220 may be configured to implement aspects of the example graphics processing pipeline 107 of FIG. 1 and/or may be configured to implement aspects of the example ML processing pipeline 108 of FIG. 1. In some examples, the GPU 220 may be configured to execute instructions that cause the GPU 220 to perform one or more of the example techniques disclosed herein.

In the illustrated example, the command engine 222 may receive ML commands (e.g., from the command buffer 230) and configure the processing elements 224 to perform various operations for carrying out the ML commands. As mentioned above, the command engine 222 and the processing elements 224 may be configured to implement aspects of the example ML processing pipeline 108 of FIG. 1.

In the illustrated example, the processing elements 224 (sometimes referred to as “shader units,” “shader cores,” or “shader processors”) may include one or more processing elements, each of which may be a programmable processing element or a fixed-function processing element. The processing elements 224 of the GPU 220 allow multiple computational jobs for an ML command to execute synchronously in a parallel manner, thereby increasing the throughput for ML commands and facilitating the GPU-based acceleration of the ML command. A programmable processing element may be configured to execute one or more shader programs that are downloaded onto the GPU 220 from the CPU 210. In some examples, a shader program may be a compiled version of a program written in a shading language. In some examples, the programmable processing elements may include compute processing elements configured to execute compute shader programs.

A fixed-function processing element may include hardware that is hard-wired to perform certain functions. Although the fixed-function processing element may be configurable to perform different functions (e.g., via one or more control signals), the fixed-function hardware may not include a program memory that is capable of received user-compiled programs (e.g., shader programs from the graphics driver 214).

Although the following description is directed to a GPU that performs compute tasks (or a subset of compute tasks, such as ML tasks), it should be appreciated that the GPU 220 may be selectively driven to perform a graphics processing task, a GPGPU task, or any other type of task suitable for a GPU based on the software (e.g., shader program(s)) loaded to run on the GPU as well as the driver used to control operation of the GPU (e.g., the graphics driver 214). Thus, while the commands may include one or more compute commands, one or more ML commands, one or more graphics commands, one or more state commands, one or more memory transfer commands, the disclosed commands are directed to ML commands that may be used by the GPU 220 to execute one or more ML primitives issued by the CPU 210.

In general, an ML command may cause the GPU 220 to generate a quantity of outputs (sometimes referred to as “primitive outputs”) associated with an ML primitive. In some such examples, once the GPU 220 receives the ML command (e.g., from the command buffer 230), control may be passed to the GPU 220 for launching one or more computational jobs for generating the requested quantity of outputs.

For example, the GPU 220 may determine a quantity of outputs associated with the executing of the ML primitive. For example, executing an ML primitive may be associated with generating 1000 outputs. The GPU 220 (and/or the command engine 222) may then determine how many computational jobs to launch to facilitate generating the requested quantity of primitive outputs. For example, if executing a computational job generates 10 job outputs, then the GPU 220 may determine to launch 100 computational jobs to generate the requested 1000 outputs for the ML primitive.

In some examples, the GPU 220 may access ML data (e.g., from the ML data buffer 232) when executing each of the launched computational jobs. For example, when launching each of the 100 computational jobs, the GPU 220 may access ML data associated with each of the respective computational jobs from the ML data buffer 232 at the memory 124, execute the respective computational jobs using the accessed ML data, and then write the output generated by executing each of the 100 computational jobs to the ML data buffer 232 of the memory 124. However, it should be appreciated that reading from the memory 124 and/or writing to the memory 124 may be associated with a memory latency due to, for example, the memory bandwidth associated with the memory 124, due to traffic on the bus 202, etc. In some examples, this general memory latency associated with accessing data (e.g., the delay between when reading data from and/or writing data to is needed and when the respective operation is completed) at the memory 124 may result in decreased performance and increased power usage when executing an ML primitive at the GPU 230.

In the illustrated example of FIG. 2, the GPU 220 includes the GPU memory 226 (GMEM) that is directly coupled to the GPU 220 so the GPU 220 may read data from and/or write data to the GPU memory 226 without using the bus 202. For example, the GPU memory 226 may be an on-chip memory that is on-chip with the GPU 220 and in relatively close proximity with components of the GPU 220 (e.g., the command engine 222 and/or the processing elements 224), and may be associated with a dedicated bus within the GPU 220. Thus, the GPU 220 may process data locally using a local storage (e.g., the GPU memory 226) without using an off-chip memory (e.g., the memory 124). In some examples, aspects of the GPU memory 226 may be implemented by the internal memory 121 of FIG. 1.

In some examples, the capacity of the GPU memory 226 may be limited by the area available at the GPU 220 (and/or, more generally, the device 104 of FIG. 1). For example, mobile devices provide physical area constraints regarding the memory size of the GPU memory 226. Thus, it may not be practical to load the input data for launching all of the computational jobs associated with an ML command to the GPU memory 226.

Accordingly, example techniques disclosed herein facilitate tile-based processing of the computational jobs. For example, disclosed techniques determine a memory size associated with the executing of a computational job and then determine how many computational jobs may be executed based on the memory size of the GPU memory 226 to determine a tile size. Example techniques may then determine how many batches of computational jobs (e.g., how may tiles) to employ to facilitate executing an ML primitive based on the size of each tile.

In the illustrated example, the GPU 220 may receive a command (e.g., via the graphics driver 214 and/or the command buffer 230 of the memory 124) associated with an ML primitive for generating a quantity of primitive outputs (e.g., 1000 outputs). The GPU 220 (and/or the command engine 222) may determine how many computational jobs to launch to generate the requested quantity of primitive outputs based on the job outputs generated by the execution of each computational job. For example, if a computational job generates 10 outputs, then the GPU 220 (and/or the command engine 222) may determine to launch 100 computational jobs, where each computational job generates 10 outputs, to generate the 1000 outputs requested for the ML primitive. It should be appreciated that in some examples, the computational jobs associated with an ML primitive may be a same computational job that is executed using different ML data.

The example GPU 220 (and/or the command engine 222) may then determine a tile size based on the memory size of the GPU memory 226 and the memory size associated with executing a computational job associated with the ML primitive. In some examples, the memory size associated with executing the computational job may be based on the memory size of the job input data associated with the executing of the computational job. For example, a computational job may use job input data that consumes five memory units. In some such examples, the GPU 220 may determine that the memory size associated with executing each computational job is five memory units. Accordingly, the GPU 220 (and/or the command engine 222) may determine the tile size to be a ratio of the memory size of the GPU memory 226 to the memory size associated with executing each computational job. For example, if the memory size of the GPU memory 226 is fifty memory units, the GPU 220 may determine the tile size to be ten computational jobs (e.g., (50 memory units)/(5 memory units per computational job)=10 computational jobs). Accordingly, each batch of computational jobs may include ten computational jobs. Furthermore, the GPU 220 may determine how many batches of computational jobs to launch based on the tile size (e.g., ten computational jobs) and the quantity of requested primitive outputs (e.g., 1000 primitive outputs). For example, in the above example, the GPU 220 may determine to launch ten batches, where each batch includes ten computational jobs, to launch the 100 computational jobs and to generate the 1000 outputs requested for the ML primitive.

In some examples, the memory size associated with executing a computational job may be based on the memory size of the job input data associated with executing a computational job associated with the ML primitive and the memory size of the job output data generated by executing the computational job. For example, in examples in which the processing elements 224 may write to the GPU memory 226, the GPU 220 may also include the memory size of the job output data when determining the memory size associated with executing a computational job. For example, executing a computational job may generate ten job outputs that consume five memory units. In some such examples, the GPU 220 may determine that the memory size associated with executing the computational job is ten memory units (e.g., five memory units associated with the job input data and five memory units associated with the job output data). Accordingly, the GPU 220 (and/or the command engine 222) may determine the size of a tile to be a ratio of the memory size of the GPU memory 226 (e.g., fifty memory units) to the memory size associated with executing the computational job (e.g., ten memory units). For example, the GPU 220 may determine the tile size to be five computational jobs (e.g., (50 memory units)/(10 memory units per computational job)=5 computational jobs). Accordingly, each batch of computational jobs may include five computational jobs. Furthermore, the GPU 220 may determine how many batches of computational jobs to launch based on the tile size (e.g., five computational jobs) and the quantity of requested primitive outputs (e.g., 1000 primitive outputs). For example, in the above example, the GPU 220 may determine to launch twenty batches, where each batch includes five computational jobs, to launch the 100 computational jobs and to generate the 1000 outputs requested for the ML primitive.

As described above, in some examples, a tile may refer to a logical block of memory. Furthermore, one or more computational jobs may be assigned to a tile based on the tile size. In some examples, when the GPU 220 (and/or the command engine 222) assigns a computational job to a tile, the GPU 220 may employ a formula to assign the computational job to the tile. In some examples, the GPU 220 (and/or the command engine 222) may also map an identifier of the computational job to the respective tile. In this manner, the GPU 220 is able to determine where to store the job output data generated by executing a computational job. For example, a fourth computational job may be assigned to a second tile. In some such examples, when job output data is generated by the execution of the fourth computational job, the GPU 220 may use the mapping between the fourth computational job and the second tile to store the respective job output data in a logical block of memory associated with the second tile.

The GPU 220 (and/or the command engine 222) may then launch the first batch of computational jobs. For example, the GPU 220 (and/or the command engine 222) may load the job input data associated with the first batch of computational jobs from the ML data buffer 232 to the GPU memory 226. For example, the GPU 220 may load a first subset of ML data from the system memory ML data buffer 232 to the GPU memory 226. The GPU 220 may then execute the first batch of computational jobs using the first subset of ML data stored at the GPU memory 226. For example, during execution of each computational job of the first batch of computational jobs, the one or more processing elements 224 may access the job input data from the GPU memory 226. As described above, by accessing the job input data from the GPU memory 226, memory read latency associated with executing each computational job may be reduced compared to when the one or more processing elements 224 accesses the job input data from the ML data buffer 232 at the memory 124.

In some examples, the one or more processing elements 224 executing the first batch of computational jobs may write the output of each computational job to the ML data buffer 232. For example, execution of each computational job may generate ten job outputs and the GPU 220 (and/or the one or more processing elements 224) may write the respective ten job outputs to the ML data buffer 232 of the memory 124. In some such examples, after completion of the first batch of computational jobs, the GPU 220 may repeat, for each subsequent batch, the loading of the respective input data, the executing of the respective computational jobs to generate job output data, and the writing (or storing) of the respective job output data to the ML data buffer 232. For example, for the second batch of computational jobs, the GPU 220 may load a second subset of ML data from the ML data buffer 232 to the GPU memory 226, execute the second batch of computational jobs to generate second job output data using the second subset of ML data from the GPU memory 226, and then write the second job output data to the ML data buffer 232, etc., until each of the ten batches of computational jobs are launched and the 1000 outputs requested for the ML primitive are generated.

In some examples, the one or more processing elements 224 executing a batch of computational jobs may be capable of writing output data to the GPU memory 226. For example, execution of each computational job may generate ten job outputs and the one or more processing elements 224 may write the ten job outputs to the GPU memory 226. In some such examples, after completion of the first batch of computational jobs, the GPU 220 may write the batch output data (e.g., the job output data generated by the execution of each computational job of the batch) from the GPU memory 226 to the memory 124 (e.g., to the ML data buffer 232). As described above, by writing the job output data to the GPU memory 226, memory write latency associated with executing each computational job may be reduced compared to when the one or more processing elements 224 writes the job out data to the ML data buffer 232 for each computational job. The GPU 220 may then repeat the loading of job input data from the ML data buffer 232 to the GPU memory 226, the executing of computational jobs to generate job output data using the job input data stored at the GPU memory 226, the writing of job output data to the GPU memory 226, and the writing of the batch output data from the GPU memory 226 to the ML data buffer 232 for each of the subsequent batches of computational jobs.

In some examples, the GPU 220 may partition the GPU memory 226 into a batch input data partition 226a for storing job input data associated with computational jobs of a batch of computational jobs and a batch output data partition 226b for storing job output data generated by the execution of the computational jobs of the batch of computational jobs. For example, when a batch of computational jobs is launched, the GPU 220 may load the job input data associated with each of the computational jobs from the ML data buffer 232 to the batch input data partition 226a of the GPU memory 226. The one or more processing elements 224 may then execute the respective computational jobs of the batch of computational jobs using the job input data (e.g., ML data) stored at the batch input data partition 226a, and then write the job output data generated by the execution of each of the respective computational jobs to the batch output data partition 226b of the GPU memory 226. The GPU 220 may then write the batch output data from the batch output data partition 226b to the ML data buffer 232 of the system memory 124 at the completion of the batch of computational jobs.

It should be appreciated that in some examples, the GPU 220 may perform the loading of job input data from the ML data buffer 232 to the batch input data partition 226a and the writing of the batch output data from the batch output data partition 226b to the ML data buffer 232 in parallel (e.g., at the same time or nearly at the same time). For example, after the executing of the first batch of computational jobs is complete and the respective job output data has been stored at the batch output data partition 226b, the GPU 220 may then begin loading job input data associated with the second batch of computational jobs to the batch input data partition 226a while also writing the batch output data generated by the execution of the first batch of computational jobs from the batch output data partition 226b to the ML data buffer 232.

As described above, in some examples, computational jobs may be assigned to respective tiles. In some such examples, computational job identifiers may be used to map the different computational jobs to respective tiles. In some examples, job output data generated by the execution of a computational job may be stored at a logical block of memory by mapping the identifier of the computational job to the respective tile and the logical block of memory associated with the tile.

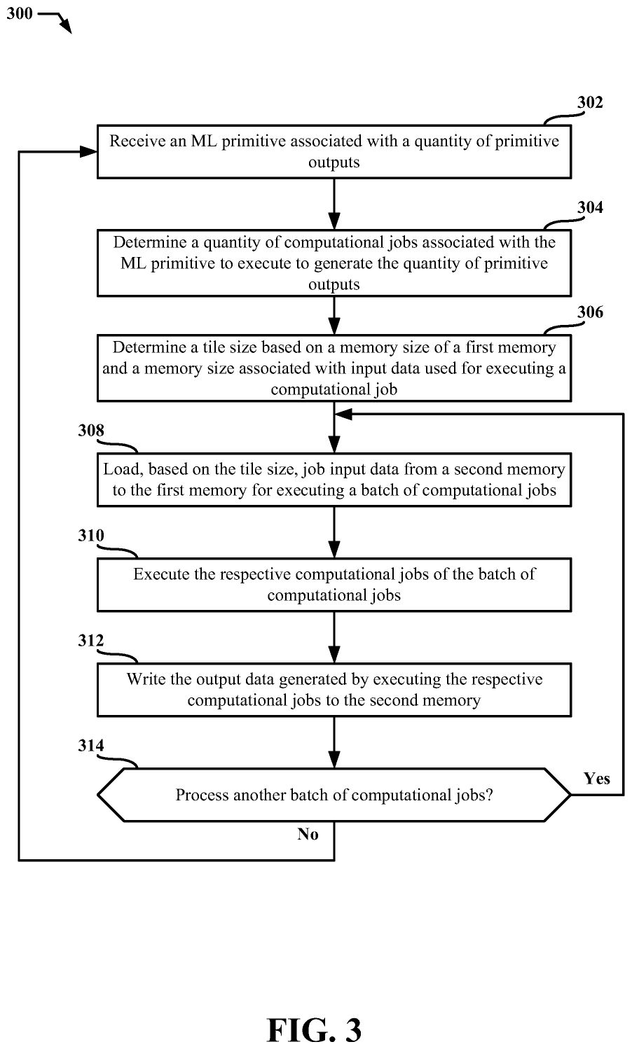

FIG. 3 illustrates an example flowchart 300 of an example method in accordance with one or more techniques of this disclosure. The method may be performed by an apparatus, such as the device 104 of FIG. 1, the processing unit 120 of FIG. 1, the ML acceleration handling component 198 of FIG. 1, the CPU 210 of FIG. 2, the GPU 220 of FIG. 2, a DPU, a video processor, and/or a component of the processing unit 120. In the example of FIG. 3, the one or more processing elements 224 of the GPU 220 may be unable to write output data to the GPU memory 226.

At 302, the apparatus may receive an ML primitive associated with a quantity of primitive outputs, as described in connection with the examples of FIGS. 1 and/or 2. For example, the GPU 220 (and/or the command engine 222) may receive an ML command associated with an ML primitive from the graphics driver 214 of the CPU 210 and/or the command buffer 230. In some examples, the GPU 220 (and/or the command engine 222) may decode the received ML command to determine the requested quantity of primitive outputs.

At 304, the apparatus may determine a quantity of computational jobs associated with the ML primitive to execute to generate the quantity of primitive outputs, as described in connection with the examples of FIGS. 1 and/or 2. For example, the GPU 220 (and/or the command engine 222) may determine the quantity of computational jobs to perform based on a ratio of the quantity of primitive outputs to the quantity of job outputs generated by each computational job. As described above, in some examples, the quantity of job outputs generated by the execution of each computational job may depend on a shader program mapping that maps to the ML primitive. In some examples, each of the computational jobs associated with the ML primitive may be a same computational job.

At 306, the apparatus may determine a tile size based on a memory size of a first memory and a memory size of input data used to execute the computational job, as described in connection with the examples of FIGS. 1 and/or 2. For example, the GPU 220 (and/or the command engine 222) may determine the tile size based on a ratio of the memory size of the first memory and the memory size of the job input data used to execute the computational job. In some examples, the GPU 220 (and/or the command engine 222) may determine a quantity of batches of computational jobs to launch based on the quantity of computational jobs to perform and the determined tile size. In some examples, the first memory may be an on-chip memory that is on-chip with the GPU 220, such as the example GPU memory 226.

At 308, the apparatus may load, based on the tile size, job input data from a second memory to the first memory for executing a batch of computational jobs, as described in connection with the examples of FIGS. 1 and/or 2. For example, the GPU 220 (and/or the command engine 222) may load a subset of ML data from the ML data buffer 232 to the GPU memory 226. In some examples, the subset of ML data loaded from the ML data buffer 232 to the GPU memory 226 may correspond to the job input data used for executing the computational jobs of the respective batch of computational jobs.

At 310, the apparatus may execute the respective computational jobs of the batch of computational jobs, as described in connection with the examples of FIGS. 1 and/or 2. As an illustrative example, the ML primitive may be associated with performing a matrix multiplication and the computational jobs associated with the ML primitive may be dot-product operation executed during the performing of the matrix multiplication. In some examples, the one or more processing elements 224 of the GPU 220 may execute the respective computational jobs associated with the ML primitive using the subset of ML data loaded to the GPU memory 226. Accordingly, the memory read latency associated with the executing of each computational job may be reduced in comparison to accessing the ML data at the ML data buffer 232 by the one or more processing elements 224 during the executing of each computational job.

At 312, the apparatus may write the output data generated by executing the respective computational jobs to the second memory, as described in connection with the examples of FIGS. 1 and/or 2. For example, the one or more processing elements 224 may write the job output data generated by executing each computational job to the ML data buffer 232.

At 314, the apparatus may determine whether to process another batch of computational jobs, as described in connection with the examples of FIGS. 1 and/or 2. For example, the GPU 220 may determine whether there is at least one more batch of computational jobs to execute (e.g., based on how many batches of computational jobs have been executed and a total quantity of batches to execute and/or based on whether the quantity of outputs generated by the completed batches of computational jobs satisfies the quantity of primitive outputs).

If, at 314, the apparatus determines to process another batch of computational jobs (e.g., there is an unexecuted batch of computational jobs and/or the quantity of outputs generated by the completed batches of computational jobs does not satisfy (e.g., is less than) the quantity of primitive outputs), then control may return to 308 to load job input data for another batch of computational jobs. If, at 314, the apparatus determines not to process another batch of computational jobs (e.g., there are no unexecuted batches of computational jobs and/or the quantity of outputs generated by the completed batches of computational jobs satisfies (e.g., is greater than or equal to) the quantity of primitive outputs), then the process may end and/or control may return to 302 to wait to receive another ML primitive.

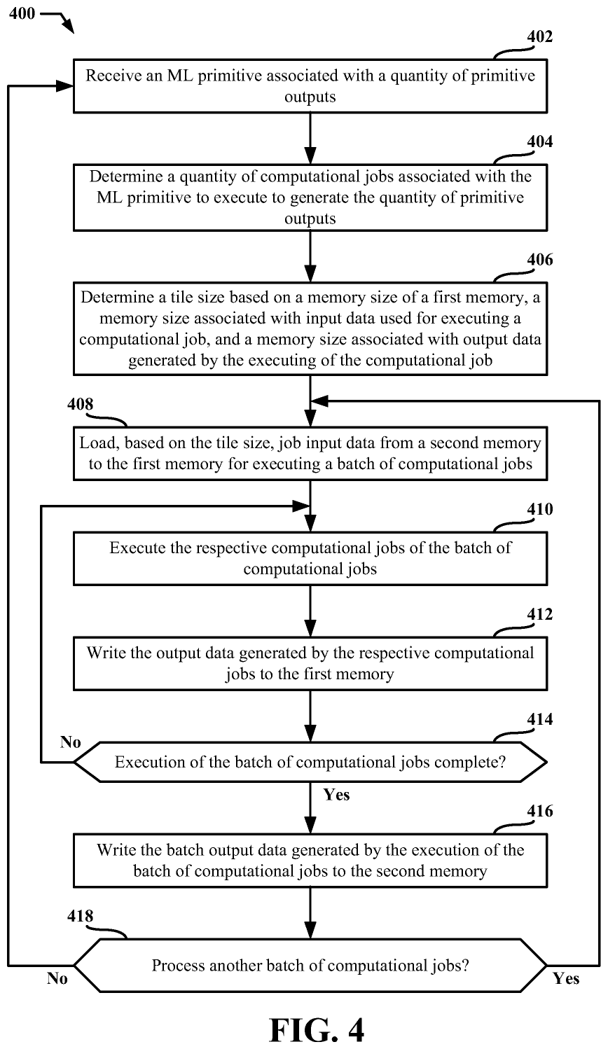

FIG. 4 illustrates an example flowchart 400 of an example method in accordance with one or more techniques of this disclosure. The method may be performed by an apparatus, such as the device 104 of FIG. 1, the processing unit 120 of FIG. 1, the ML acceleration handling component 198 of FIG. 1, the CPU 210 of FIG. 2, the GPU 220 of FIG. 2, a DPU, a video processor, and/or a component of the processing unit 120. In the example of FIG. 4, the one or more processing elements 224 of the GPU 220 may be capable of writing output data to the GPU memory 226.

At 402, the apparatus may receive an ML primitive associated with a quantity of primitive outputs, as described in connection with the examples of FIGS. 1 and/or 2. For example, the GPU 220 (and/or the command engine 222) may receive an ML command associated with an ML primitive from the graphics driver 214 of the CPU 210 and/or the command buffer 230 of the system memory 124. In some examples, the GPU 220 (and/or the command engine 222) may decode the received ML command to determine the quantity of requested primitive outputs.

At 404, the apparatus may determine a quantity of computational jobs associated with the ML primitive to execute to generate the quantity of primitive outputs, as described in connection with the examples of FIGS. 1 and/or 2. For example, the GPU 220 (and/or the command engine 222) may determine the quantity of computational jobs to perform based on a ratio of the quantity of primitive outputs to the quantity of job outputs generated by each computational job. As described above, in some examples, the quantity of job outputs generated by the execution of each computational job may depend on a shader program mapping that maps to the ML primitive. In some examples, each of the computational jobs associated with the ML primitive may be a same computational job

At 406, the apparatus may determine a tile size based on a memory size of a first memory, a memory size of input data used to perform the computational job, and a memory size of output data generated by the execution of the computational job, as described in connection with the examples of FIGS. 1 and/or 2. For example, the GPU 220 (and/or the command engine 222) may determine the tile size based on a ratio of the memory size of the first memory and the memory resources associated with executing the computational job. For example, the memory resources associated with executing the computational job may include a memory size of input data used to execute the computational job and a memory size of output data generated by the execution of the computational job. In some examples, the GPU 220 (and/or the command engine 222) may determine a quantity of batches of computational jobs to launch based on the quantity of computational jobs to execute and the determined tile size. In some examples, the first memory may be an on-chip memory that is on-chip with the GPU 220, such as the example GPU memory 226.

At 408, the apparatus may load, based on the tile size, job input data from a second memory to the first memory for executing a batch of computational jobs, as described in connection with the examples of FIGS. 1 and/or 2. For example, the GPU 220 (and/or the command engine 222) may load a subset of ML data from the ML data buffer 232 to the GPU memory 226. In some examples, the subset of ML data loaded from the ML data buffer 232 to the GPU memory 226 may correspond to the job input data used for executing the computational jobs of the respective batch of computational jobs. In some examples, the GPU 220 (and/or the command engine 222) may load the subset of ML data from the ML data buffer 232 to the batch input data partition 226a of the GPU memory 226.

At 410, the apparatus may execute the respective computational jobs of the batch of computational jobs, as described in connection with the examples of FIGS. 1 and/or 2. For example, the one or more processing elements 224 of the GPU 220 may execute the respective computational jobs associated with the ML primitive using the subset of ML data loaded to the batch input data partition 226a of the GPU memory 226. Accordingly, the memory read latency associated with the executing of each computational job may be reduced in comparison to accessing the ML data at the ML data buffer 232 by the one or more processing elements 224 during the executing of each computational job.

At 412, the apparatus may write the output data generated by executing the respective computational jobs to the first memory, as described in connection with the examples of FIGS. 1 and/or 2. For example, the one or more processing elements 224 may write the job output data generated by executing each computational job to the batch output data partition 226b of the GPU memory 226.

At 414, the apparatus may determine whether execution of the batch of computational jobs is complete, as described in connection with the examples of FIGS. 1 and/or 2. For example, the GPU 220 may determine whether each of the computational jobs of the batch of computational jobs is executed and that the respective job outputs have been written to the batch output data partition 226b of the GPU memory 226.

If, at 414, the apparatus determines that execution of the batch of computational jobs is not complete (e.g., there are unexecuted or incomplete computational jobs of the batch of computational jobs), then control may return to 410 to continue executing the respective computational jobs of the batch of computational jobs.

If, at 414, the apparatus determines that execution of the batch of computational jobs is complete (e.g., the one or more processing elements 224 have executed the respective computational jobs of the batch of computational jobs), then control may proceed to 416 to write the batch output data generated by the execution of the batch of computational jobs to the second memory, as described in connection with the examples of FIGS. 1 and/or 2. For example, the GPU 220 may write the batch output data from the batch output data partition 226b of the GPU memory 226 to the ML data buffer 232.

At 418, the apparatus may determine whether to process another batch of computational jobs, as described in connection with the examples of FIGS. 1 and/or 2. For example, the GPU 220 may determine whether there is at least one more batch of computational jobs to execute (e.g., based on how many batches of computational jobs have been executed and a total quantity of batches to execute and/or based on whether the quantity of outputs generated by the completed batches of computational jobs satisfies the quantity of primitive outputs).

If, at 418, the apparatus determines to process another batch of computational jobs (e.g., there is an unexecuted batch of computational jobs and/or the quantity of outputs generated by the completed batches of computational jobs does not satisfy (e.g., is less than) the quantity of primitive outputs), then control may return to 408 to load job input data to the batch input data partition 226a of the GPU memory 226 for another batch of computational jobs. If, at 418, the apparatus determines not to process another batch of computational jobs (e.g., there are no unexecuted batches of computational jobs and/or the quantity of outputs generated by the completed batches of computational jobs satisfies (e.g., is greater than or equal to) the quantity of primitive outputs), then the process may end and/or control may return to 402 to wait to receive another ML primitive.

It should be appreciated that in some examples, the apparatus may execute the loading of job input data from the ML data buffer 232 to the batch input data partition 226a of the GPU memory 226 in parallel with the writing of the output data from the batch output data partition 226b of the GPU memory 226 to the ML data buffer 232. For example, after the one or more processing elements 224 write the output data from a first batch of computational jobs to the batch output data partition 226b of the GPU memory 226, the GPU 220 may load job input data associated with a second batch of computational jobs while also writing the batch output data associated with the first batch of computational jobs from the batch output data partition 226b of the GPU memory 226 to the system memory 124. Thus, it may be appreciated that in some examples, the GPU 220 may interleave memory accesses between the ML data buffer 232 and the GPU memory 226 between the loading of job input data (e.g., from the ML data buffer 232 to the batch input data partition 226a of the GPU memory 226) associated with a second batch of computational jobs and the writing of batch output data (e.g., from the batch output data partition 226 of the GPU memory 226 to the ML data buffer 232) associated with a first batch of computational jobs.

In one configuration, a method or apparatus for machine learning processing is provided. The apparatus may be a processing unit, a GPU, a display processor, a DPU, a video processor, or some other processor that can perform machine learning processing. In some examples, the apparatus may be the processing unit 120 within the device 104, or may be some other hardware within the device 104, or another device. The apparatus may include means for determining a tile size based on a memory size of a first memory and a job input size associated with executing a computational job, and where the computational job is one of a quantity of computational jobs configured to execute a machine learning primitive. The apparatus may also include means for loading, based on the tile size, input data associated with a batch of computational jobs from a second memory to the first memory. Further, the apparatus may include means for generating batch output data by executing the batch of computational jobs using the input data loaded to the first memory. Also, the apparatus may include means for storing the generated batch output data to the second memory. The apparatus may also include means for determining the job input size associated with executing the computational job based on a memory size of input data used to execute the computational job. The apparatus may also include means for determining the tile size based on a job output size associated with executing the computational job, and where the job output size is determined based on a memory size of output data generated by the execution of the computational job. The apparatus may also include means for writing the output data generated by the execution of each computational job of the batch of computational jobs to the first memory. Also, the apparatus may include means for storing the generated output data from the first memory to the second memory after execution of the batch of computational jobs is complete. The apparatus may also include means for loading input data associated with a second batch of computational jobs from the second memory to the first memory. The apparatus may also include means for loading the input data associated with the second batch of computational jobs in parallel with the storing of the generated output data to the second memory. The apparatus may also include means for loading second input data associated with executing a second batch of computational jobs from the second memory to the first memory. Further, the apparatus may include means for generating second batch output data by executing the second batch of computational jobs using the second input data loaded to the first memory. Additionally, the apparatus may include means for storing the generated second batch output data to the second memory.

The subject matter described herein can be implemented to realize one or more benefits or advantages. For instance, the described compute and/or ML processing techniques can be used by a GPU, a display processor, a DPU, or a video processor or some other processor that can perform tile-based machine learning acceleration techniques disclosed herein. Moreover, the compute and/or ML processing techniques herein can improve or speed up data processing or execution. Further, the compute and/or ML processing techniques herein can improve resource or data utilization and/or resource efficiency. For example, aspects of the present disclosure can reduce read memory latency and/or write memory latency of a processing unit.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily need realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method of machine learning processing, comprising:
determining a tile size based on a memory size of a first memory and a job input size associated with executing a computational job, the computational job being one of a quantity of computational jobs configured to execute a machine learning primitive;
loading, based on the tile size, input data associated with a batch of computational jobs from a second memory to the first memory;
generating batch output data by executing the batch of computational jobs using the input data loaded to the first memory; and
storing the generated batch output data to the second memory.

2. The method of claim 1, wherein the first memory is associated with a first latency, and the second memory is associated with a second latency that is greater than the first latency.

3. The method of claim 1, wherein the job input size associated with executing the computational job is determined based on a memory size of input data used to execute the computational job.

4. The method of claim 1, wherein the determining of the tile size is further based on a job output size associated with executing the computational job, and wherein the job output size is determined based on a memory size of output data generated by the execution of the computational job.

5. The method of claim 4, wherein the storing of the generated batch output data to the second memory further comprises:
writing the output data generated by the execution of each computational job of the batch of computational jobs to the first memory; and
storing the generated output data from the first memory to the second memory after execution of the batch of computational jobs is complete.

6. The method of claim 5, wherein the batch of computational jobs is a first batch of computational jobs, and further comprising loading input data associated with a second batch of computational jobs from the second memory to the first memory, the loading of the input data associated with the second batch of computational jobs being performed in parallel with the storing of the generated output data to the second memory after execution of the first batch of computational jobs is complete.

7. The method of claim 1, further comprising:
loading second input data associated with executing a second batch of computational jobs from the second memory to the first memory;
generating second batch output data by executing the second batch of computational jobs using the second input data loaded to the first memory; and
storing the generated second batch output data to the second memory.

8. The method of claim 1, wherein the first memory is an on-chip memory of a graphics processor.

9. The method of claim 8, wherein the second memory is accessible to the graphics processor and to a central processor.

10. The method of claim 8, wherein the graphics processor comprises a plurality of processing elements configured to execute the batch of computational jobs.

11. The method of claim 1, wherein the tile size corresponds to a quantity of computational jobs of the batch of computational jobs.

12. An apparatus for machine learning processing, comprising:
a memory; and
at least one processor coupled to the memory and configured to:
determine a tile size based on a memory size of a first memory and a job input size associated with executing a computational job, the computational job being one of a quantity of computational jobs configured to execute a machine learning primitive;
load, based on the tile size, input data associated with a batch of computational jobs from a second memory to the first memory;
generate batch output data by executing the batch of computational jobs using the input data loaded to the first memory; and
store the generated batch output data to the second memory.

13. The apparatus of claim 12, wherein the first memory is associated with a first latency, and the second memory is associated with a second latency that is greater than the first latency.

14. The apparatus of claim 12, wherein the job input size associated with executing the computational job is determined based on a memory size of input data used to execute the computational job.

15. The apparatus of claim 12, wherein the at least one processor is configured to determine the tile size based on a job output size associated with executing the computational job, the job output size being determined based on a memory size of output data generated by the execution of the computational job.

16. The apparatus of claim 15, wherein the at least one processor is configured to store the generated batch output data to the second memory by:
writing the output data generated by the execution of each computational job of the batch of computational jobs to the first memory; and
storing the generated output data from the first memory to the second memory after execution of the batch of computational jobs is complete.

17. The apparatus of claim 16, wherein the batch of computational jobs is a first batch of computational jobs, and the at least one processor is configured to load input data associated with a second batch of computational jobs from the second memory to the first memory, the loading of the input data associated with the second batch of computational jobs being performed in parallel with the storing of the generated output data to the second memory after execution of the first batch of computational jobs is complete.

18. The apparatus of claim 12, wherein the at least one processor is further configured to:
load second input data associated with executing a second batch of computational jobs from the second memory to the first memory;
generate second batch output data by executing the second batch of computational jobs using the second input data loaded to the first memory; and
store the generated second batch output data to the second memory.

19. The apparatus of claim 12, wherein the first memory is an on-chip memory of a graphics processor.

20. The apparatus of claim 19, wherein the second memory is accessible to the graphics processor and to a central processor.

21. The apparatus of claim 12, wherein the at least one processor comprises a plurality of processing elements configured to execute the batch of computational jobs.

22. The apparatus of claim 12, wherein the tile size corresponds to a quantity of computational jobs of the batch of computational jobs.

23. The apparatus of claim 12, wherein the apparatus includes a wireless communication device.

24. A non-transitory computer-readable medium storing computer executable code for machine learning processing, comprising code to:
determine a tile size based on a memory size of a first memory and a job input size associated with executing a computational job, the computational job being one of a quantity of computational jobs configured to execute a machine learning primitive;
load, based on the tile size, input data associated with a batch of computational jobs from a second memory to the first memory;
generate batch output data by executing the batch of computational jobs using the input data loaded to the first memory; and
store the generated batch output data to the second memory.
